(19) United States
(12) Patent Application Publication
(10) Pub. No.: US 2026/0330942 A1
(43) Pub. Date: Oct. 22, 2026

(54) Radar-assisted intelligent network camera

(71) Applicant: Shenzhen Fusi Kangmu Intelligent Technology Co., Ltd., Shenzhen (CN)

(72) Inventors: Sanwei DENG, Shenzhen (CN); Yongkun QI, Shenzhen (CN); Neng PAN, Shenzhen (CN); Yongcheng FANG, Shenzhen (CN)

(73) Assignee: Shenzhen Fusi Kangmu Intelligent Technology Co., Ltd., Shenzhen (CN)

(21) Appl. No.: 19/433,662

(22) Filed: Dec. 26, 2025

(30) Foreign Application Priority Data
Apr. 22, 2025 (CN) 202520772931.7

(51) Int. Cl. G08B 13/196

(52) U.S. Cl. CPC G08B 13/1963; G08B 13/19619; G08B 13/19636; G08B 13/19652; G08B 13/19663

(57) ABSTRACT

Disclosed is a radar-assisted intelligent network camera, which relates to the technical field of video monitoring. A visual component is rotatably arranged on a camera body, the camera body is rotatably arranged on a base, and the base is internally provided with a control unit. The camera body is internally provided with a first radar detection unit and a second radar detection unit, and the first radar detection unit and the second radar detection unit are located at two opposite sides of the visual component respectively. The visual component rotates by an angle through cooperation of the first radar detection unit and the second radar detection unit, so as to quickly detect a viewing blind zone.

### RELATED APPLICATIONS

The present patent document claims the benefit of priority to Patent Application No. 202520772931.7, filed Apr. 22, 2025, and entitled “RADAR-ASSISTED INTELLIGENT NETWORK CAMERA,” the entire contents of each of which are incorporated herein by reference.

### BACKGROUND

### 1. Technical Field

The present disclosure relates to the technical field of video monitoring, and particularly relates to a radar-assisted intelligent network camera.

### 2. Background Information

At present, intelligent network cameras generally rely on visual sensors for environmental monitoring. However, they have problems of viewing blind zones due to their fixed viewing angles or preset rotation modes, which easily lead to monitoring blind spots and response delay especially in dynamic obstruction or fast target tracking scenes. Existing improvement solutions expand a monitoring range by increasing a rotational degree of freedom of cameras or integrating single radar modules, and still face obvious limitations. For example, single radar has a limited detection angle and can hardly cover multi-directional blind zones. Moreover, camera rotation depends on program presetting or visual feedback, so a visual sensor cannot sense a target in a viewing blind zone and thus cannot track it. In addition, external radar or a centralized layout can easily lead to a huge device and higher cost, which can hardly satisfy requirements of compact deployment and thus needs to be improved.

### BRIEF SUMMARY

A main objective of the present disclosure is to provide a radar-assisted intelligent network camera, so as to solve a problem of failure to track a target in a viewing blind zone.

To achieve the objective, the present disclosure provides a radar-assisted intelligent network camera. The intelligent network camera includes:

a visual component;

a camera body, where the visual component is rotatably arranged on the camera body; and

a base, where the camera body is rotatably arranged on the base, and the base is internally provided with a control unit.

The camera body is internally provided with a first radar detection unit and a second radar detection unit. The first radar detection unit and the second radar detection unit are located at two opposite sides of the visual component respectively. The first radar detection unit and the second radar detection unit are electrically connected to the control unit. The control unit is electrically connected to the visual component. The visual component rotates by an angle through cooperation of the first radar detection unit and the second radar detection unit, so as to quickly detect a viewing blind zone.

Preferably, the camera body includes a camera housing and a middle frame arranged in the camera housing.

The first radar detection unit and the second radar detection unit are fixedly connected to an outer side of the middle frame through corresponding connectors. Detection viewing ranges of the first radar detection unit and the second radar detection unit do not overlap with each other.

Preferably, detection angle ranges of the first radar detection unit and the second radar detection unit are 120 degrees.

Preferably, the connectors include a plurality of fastening bolts.

Preferably, the camera housing is internally provided with a first driving motor. An output end of the first driving motor is connected to a first rotating shaft. One end of the first rotating shaft farther from the first driving motor is rotatably connected to the base.

Preferably, the visual component includes a visual housing, a visual processing unit, a second rotating shaft, and a second driving motor. The visual processing unit is embedded in a surface of the visual housing.

The second driving motor is arranged in the visual housing. One end of the second rotating shaft is connected to the output end of the first driving motor. The other end of the second rotating shaft penetrates the visual housing so as to be rotatably connected to the camera body.

Preferably, the camera housing is internally provided with a wire. One end of the camera housing facing the base is provided with a wire groove.

One end of the base facing the wire groove is provided with a mounting plate. The mounting plate is provided with a protective element. The wire penetrates the wire groove and the protective element to enter the base.

Preferably, the protective element includes a protective plate. The protective plate is provided with a notch for a rotation path of the wire along with the camera body.

Preferably, the notch is curved.

Preferably, one side of the base farther from the camera body is provided with an annular gasket.

The present disclosure has the beneficial effects as follows: Through collaborative detection of the first radar detection unit and the second radar detection unit symmetrically arranged at two sides of the camera body, in combination with a dynamic linkage mechanism of the control unit, problems of insufficient blind zone coverage and response lag of a traditional camera with a fixed viewing angle or single radar assistance are effectively solved. Then, dual radar monitors targets in blind zones at the two sides of the visual component in real time, and triggers quick rotation and tracking of the camera, such that target capture time is significantly shortened. Further, an integrated design of arranging the first radar detection unit and the second radar detection unit in the camera body can reduce a size and cost of a device and improve mounting convenience. Finally, by combining a characteristic that the first radar detection unit and the second radar detection unit are not influenced by illumination, an all-weather monitoring ability in a complex environment is enhanced, and finally blind zone elimination and dynamic target tracking with high efficiency, accuracy and low power consumption are implemented.

### BRIEF DESCRIPTION OF THE DRAWINGS

To describe embodiments of the present disclosure or technical solutions in the prior art more clearly, drawings required for description of the embodiments or the prior art will be briefly introduced below. Obviously, the drawings in the following description are merely some embodiments of the present disclosure. Those of ordinary skill in the art can further obtain other drawings according to structures shown in the drawings without creative efforts.

FIG. 1 is a schematic structural diagram of a perspective view of the present disclosure.

FIG. 2 is a cutaway view of the present disclosure.

FIG. 3 is an exploded view of the present disclosure.

### BRIEF DESCRIPTION OF NUMBERS

1, visual component; 11, second driving motor; 12, second rotating shaft; 13, visual processing unit;
2, camera body; 21, camera housing; 22, middle frame; 23, first radar detection unit; 24, second radar detection unit; 25, connector; 26, first driving motor; 27, first rotating shaft;
3, base; 31, mounting plate; 311, protective element; 3111, notch; and 32, gasket.

Implementation, functional characteristics and advantages of the present disclosure will be further described with reference to the accompanying drawings in combination with the embodiments.

### DETAILED DESCRIPTION OF THE DRAWINGS AND THE PRESENTLY PREFERRED EMBODIMENTS

Technical solutions in embodiments of the present disclosure will be clearly and completely described below in combination with drawings in the embodiments of the present disclosure. Obviously, the embodiments described are merely some embodiments rather than all the embodiments of the present disclosure. Based on the embodiments of the present disclosure, all other embodiments obtained by those of ordinary skill in the art without making creative efforts fall within the protection scope of the present disclosure.

It should be noted that if a directional indication (such as upper, lower, left, right, front, or rear) is involved in the embodiments of the present disclosure, the directional indication is only used to describe a relative positional relationship, a movement situation, etc. between components in a posture (as shown in the drawings). If the specific posture changes, the directional indication changes accordingly.

In addition, if the embodiments of the present disclosure involve descriptions such as “first” and “second”, the descriptions such as “first” and “second” are only for descriptive purposes and are not to be construed as indicating or implying their relative importance or implicitly specifying a quantity of indicated technical features. Thus, a feature defined with “first” and “second” may explicitly or implicitly include at least one of the features. In addition, if “and/or” appearing herein means that three parallel solutions are included. With “A and/or B” as an example, solution A is included, solution B is included, or solutions A and B are simultaneously included. Further, the technical solutions between all the embodiments may be combined with each other on the premise that combinations of the technical solutions can be implemented by those of ordinary skill in the art. If the combinations of the technical solutions contradict or cannot be implemented, it should be considered that they do not exist, and do not fall within the protection scope of the present disclosure.

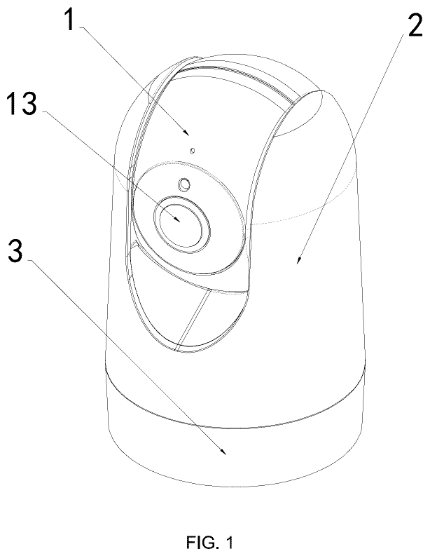

The present disclosure provides a radar-assisted intelligent network camera. With reference to FIG. 1 to FIG. 3, the intelligent network camera includes a visual component 1, a camera body 2, where the visual component 1 is rotatably arranged on the camera body 2, and a base 3. The camera body 2 is rotatably arranged on the base 3. The base 3 is internally provided with a control unit. The camera body 2 is internally provided with a first radar detection unit 23 and a second radar detection unit 24. The first radar detection unit 23 and the second radar detection unit 24 are located at two opposite sides of the visual component 1 respectively. The first radar detection unit 23 and the second radar detection unit 24 are electrically connected to the control unit. The control unit is electrically connected to the visual component 1. The visual component 1 rotates by an angle through cooperation of the first radar detection unit 23 and the second radar detection unit 24, so as to quickly detect a viewing blind zone.

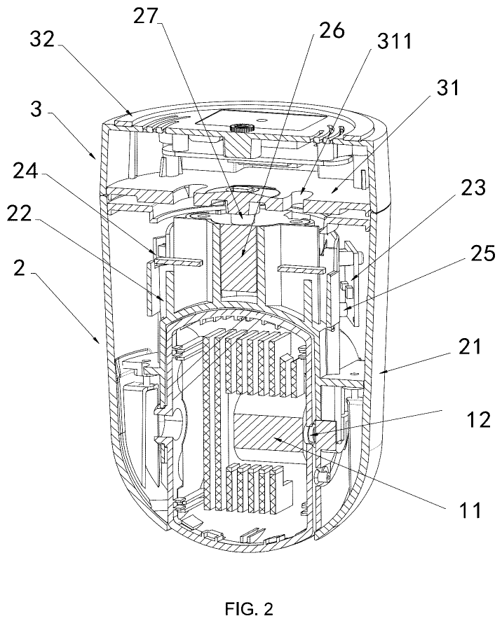

With reference to FIG. 2, in the above design, through collaborative detection of the first radar detection unit 23 and the second radar detection unit 24 symmetrically arranged at two sides of the camera body 2, in combination with a dynamic linkage mechanism of the control unit, problems of insufficient blind zone coverage and response lag of a traditional camera with a fixed viewing angle or single radar assistance are effectively solved. Then, dual radar monitors targets in blind zones at the two sides of the visual component 1 in real time, and triggers quick rotation and tracking of the camera, such that target capture time is significantly shortened. Further, an integrated design of arranging the first radar detection unit 23 and the second radar detection unit 24 in the camera body 2 can reduce a size and cost of a device and improve mounting convenience. Finally, by combining a characteristic that the first radar detection unit 23 and the second radar detection unit 24 are not influenced by illumination, an all-weather monitoring ability in a complex environment is enhanced, and finally blind zone elimination and dynamic target tracking with high efficiency, accuracy and low power consumption are implemented.

In the embodiment, the camera body 2 includes a camera housing 21 and a middle frame 22 arranged in the camera housing 21. The first radar detection unit 23 and the second radar detection unit 24 are fixedly connected to an outer side of the middle frame 22 through corresponding connectors 25. The arrangement is used to fix positions of the first radar detection unit 23 and the second radar detection unit 24, so as to prevent the situation that the first radar detection unit 23 and the second radar detection unit 24 deviate from original positions when the camera body 2 is externally stressed, leading to change of a detection angle range and further influencing target tracking of the visual component 1. Further, detection viewing ranges of the first radar detection unit 23 and the second radar detection unit 24 do not overlap with each other, such that a target in a blind zone of the visual component 1 in a current state can be detected, which facilitates tracking of the visual component 1, and tracking and monitoring of the target in all directions.

It should be noted that in the embodiment, detection angle ranges of the first radar detection unit 23 and the second radar detection unit 24 are 120 degrees.

In the embodiment, the connectors 25 include a plurality of fastening bolts, and are configured to fasten the first radar detection unit 23 and the second radar detection unit 24 at predetermined positions. Essentially, in other embodiments, the connectors 25 may be screws or buckle structures, as long as the first radar detection unit 23 and the second radar detection unit 24 can be stably fixed to the predetermined positions.

Specifically, with reference to FIG. 2, the camera housing 21 is internally provided with a first driving motor 26. An output end of the first driving motor 26 is connected to a first rotating shaft 27. One end of the first rotating shaft 27 farther from the first driving motor 26 is rotatably connected to the base 3. Through the arrangement, the camera body 2 can rotate in an axial direction, and then an orientation of the visual component 1 can be changed, such that the visual component 1 can track a target in a blind zone at its side.

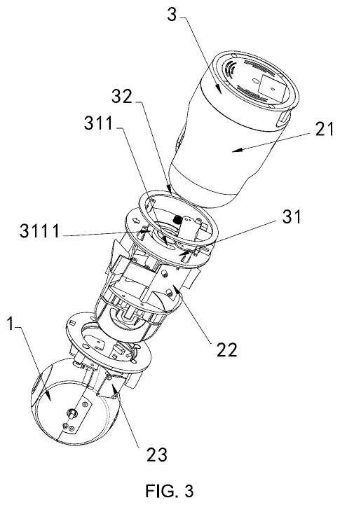

Further, with reference to FIG. 2 and FIG. 3, the visual component 1 includes a visual housing, a visual processing unit 13, a second rotating shaft 12, and a second driving motor 11. The visual processing unit 13 is embedded in a surface of the visual housing. The second driving motor 11 is arranged in the visual housing. One end of the second rotating shaft 12 is connected to the output end of the first driving motor 26. The other end of the second rotating shaft penetrates the visual housing so as to be rotatably connected to the camera body 2. The arrangement achieves rotation of the visual component 1, and further adjusts a detection angle range of the visual processing unit 13.

In the embodiment, with reference to FIG. 2 and FIG. 3, the camera housing 21 is internally provided with a wire. One end of the camera housing 21 facing the base 3 is provided with a wire groove. One end of the base 3 facing the wire groove is provided with a mounting plate 31. The mounting plate 31 is provided with a protective element 311. The wire penetrates the wire groove and the protective element 311 to enter the base 3. The protective element 311 includes a protective plate. The protective plate is provided with a notch 3111 for a rotation path of the wire along with the camera body 2. Through the arrangement, on one hand, winding damage of the wire between the camera body 2 and the base 3 when the camera body 2 rotates can be avoided. On the other hand, resistance appearing when the camera body 2 rotates can be reduced. In this way, the camera body 2 rotates more flexibly, and then the visual component 1 can quickly track and monitor the target. In other words, the design further improves sensitivity of the intelligent network camera.

Further, with reference to FIG. 3, in the embodiment, the notch 3111 is curved. The design ensures that the wire between the camera body 2 and the base 3 can smoothly move in a rotation direction of the camera body 2.

In the embodiment, one side of the base 3 farther from the camera body 2 is provided with an annular gasket 32. The arrangement prevents the intelligent network camera from damaging a wall or other surfaces due to long-term contact when the intelligent network camera is fixed to the wall or other surfaces. Then, when the intelligent network camera is placed on a desktop, the annular gasket 32 enhances a rubbing effect, such that the intelligent network camera can be placed on the desktop more stably.

For the intelligent network camera, firstly, it should be noted that, conventionally, the visual component 1 may track a target existing in a visual range, and when the target moves, the visual component 1 may rotate accordingly for real-time monitoring. However, when a distant target moves toward the visual component 1 and is located in the blind zone of the visual component 1 in the current state, the visual component 1 cannot detect the target and track the target. Thus, it is necessary to arrange other detection apparatuses in the viewing blind zone of the visual component 1. The present disclosure uses a design of the first radar detection unit 23 and the second radar detection unit 24 to overcome the above defects. The first radar detection unit 23 and the second radar detection unit 24 in the camera housing 21 can detect the target in the blind zone of the visual component 1, and then the control unit can transmit signals to the camera body 2 and the visual component 1. After receiving corresponding data, the camera body 2 and the visual component 1 rotate accordingly, such that the visual component 1 can track the target and then monitor the target.

What are described above are merely optional embodiments of the present disclosure and do not limit the patent scope of the present disclosure. Under the inventive concept of the present disclosure, any equivalent structural transformation made through contents of the description and drawings of the present disclosure, or direct/indirect application in other related technical fields fall within the patent protection scope of the present disclosure.

1. A radar-assisted intelligent network camera, comprising:
a visual component;
a camera body, wherein the visual component is rotatably arranged on the camera body; and
a base, wherein the camera body is rotatably arranged on the base, and the base is internally provided with a control unit, wherein
the camera body is internally provided with a first radar detection unit and a second radar detection unit, the first radar detection unit and the second radar detection unit are located at two opposite sides of the visual component respectively, the first radar detection unit and the second radar detection unit are electrically connected to the control unit, the control unit is electrically connected to the visual component, and the visual component rotates by an angle through cooperation of the first radar detection unit and the second radar detection unit, so as to quickly detect a viewing blind zone.

2. The intelligent network camera according to claim 1, wherein the camera body comprises a camera housing and a middle frame arranged in the camera housing; and
the first radar detection unit and the second radar detection unit are fixedly connected to an outer side of the middle frame through corresponding connectors, and detection viewing ranges of the first radar detection unit and the second radar detection unit do not overlap with each other.

3. The intelligent network camera according to claim 2, wherein detection angle ranges of the first radar detection unit and the second radar detection unit are 120 degrees.

4. The intelligent network camera according to claim 2, wherein the connectors comprise a plurality of fastening bolts.

5. The intelligent network camera according to claim 4, wherein the camera housing is internally provided with a first driving motor, an output end of the first driving motor is connected to a first rotating shaft, and one end of the first rotating shaft farther from the first driving motor is rotatably connected to the base.

6. The intelligent network camera according to claim 5, wherein the visual component comprises a visual housing, a visual processing unit, a second rotating shaft, and a second driving motor, and the visual processing unit is embedded in a surface of the visual housing; and
the second driving motor is arranged in the visual housing, one end of the second rotating shaft is connected to the output end of the first driving motor, and the other end of the second rotating shaft penetrates the visual housing so as to be rotatably connected to the camera body.

7. The intelligent network camera according to claim 2, wherein the camera housing is internally provided with a wire, and one end of the camera housing facing the base is provided with a wire groove; and
one end of the base facing the wire groove is provided with a mounting plate, the mounting plate is provided with a protective element, and the wire penetrates the wire groove and the protective element to enter the base.

8. The intelligent network camera according to claim 7, wherein the protective element comprises a protective plate, and the protective plate is provided with a notch for a rotation path of the wire along with the camera body.

9. The intelligent network camera according to claim 8, wherein the notch is curved.

10. The intelligent network camera according to claim 1, wherein one side of the base farther from the camera body is provided with an annular gasket.
